(19) United States
(12) Patent Application Publication
(10) Pub. No.: US 2019/0007637 A1
(43) Pub. Date: Jan. 3, 2019

(54) AD CONVERTER AND SOLID-STATE IMAGE SENDING DEVICE

(71) Applicant: Renesas Electronics Corporation, Tokyo (JP)

(72) Inventor: Osamu NISHIKIDO, Tokyo (JP)

(73) Assignee: Renesas Electronics Corporation, Tokyo (JP)

(21) Appl. No.: 16/005,787

(22) Filed: Jun. 12, 2018

(30) Foreign Application Priority Data
Jun. 30, 2017 (JP) 2017-128729

(51) Int. Cl. H04N 5/378; H04N 5/359; H04N 5/365; H04N 5/341

(52) U.S. Cl. CPC H04N 5/378; H04N 5/341; H04N 5/3658; H04N 5/359

(57) ABSTRACT

The present disclosure is provided to solve a problem that a signal obtained by imaging with low illumination cannot be amplified while suppressing random noise. An AD converter outputs n bits. A digital converting unit converts each of P pieces of analog signals output from the same place at different times to a digital value of (n−m) bits. An addition circuit integrates P pieces of the converted digital values. Here, n denotes a natural number of 1 or larger, m denotes a natural number of 1 or larger and less than n, and P denotes a natural number of 1 or larger and m or less.

### CROSS-REFERENCE TO RELATED APPLICATIONS

The disclosure of Japanese Patent Application No. 2017-128729 filed on Jun. 30, 2017 including the specification, drawings and abstract is incorporated herein by reference in its entirety.

### BACKGROUND

The present disclosure relates to an AD converter and a solid-state image sensing device and, for example, can be suitably used for a surveillance camera.

In recent years, needs for imaging with low illumination are increasing in a surveillance camera and the like. To amplify a signal obtained by imaging with low illumination, it is necessary to mount a high-gain circuit. However, there is a problem such that when the gain is simply increased, the gain is applied also to a noise component

Patent Literature 1 (Japanese Unexamined Patent Application Publication No. 2012-004727) discloses a solid-state image sensing device in which, to reduce noise, sampling of a reset level of a pixel is performed a plurality of times, results of the sampling of the plurality of times are integrated by a digital integration circuit, and the integration results are averaged.

### SUMMARY

However, an AD converter described in the patent literature 1 cannot amplify a signal obtained by imaging with low illumination while suppressing random noise.

The other objects and novel features will become apparent from the description of the specification and appended drawing

An AD converter outputting n bits in an embodiment includes: a digital converting unit converting each of P pieces of analog signals output from the same place at different times to a digital value of (n−m) bits; and an addition circuit integrating converted P pieces of digital values. Here, n denotes a natural number of 1 or larger, m denotes a natural number which is 1 or larger and is less than n, and P denotes a natural number which is 1 or larger and is m or less.

According to the embodiment, while suppressing random noise, an analog signal obtained by imaging with low illumination can be amplified.

### BRIEF DESCRIPTION OF THE DRAWINGS

FIG. 1 is a diagram illustrating the configuration of an AD converter of a first embodiment.

FIG. 2 is a diagram illustrating the configuration of a solid-state image sensing device.

FIG. 3 is a diagram illustrating the configuration of an AD converter of reference example 1.

FIG. 4 is a timing chart of operation of the AD converter of the reference example 1 when n=12 and m=1.

FIG. 5 is a diagram illustrating the configuration of an AD converter of a second embodiment.

FIG. 6 is a timing chart of operation of the AD converter of the second embodiment when n=12 and m=1.

FIG. 7 is a diagram illustrating the configuration of a pixel and a column ADC of reference example 2.

FIG. 8 is a timing chart of operation of the pixel and the column ADC when n=12 in the reference example 2.

FIG. 9 is a diagram illustrating the configuration of a pixel and a column ADC of a third embodiment.

FIG. 10 is a timing chart of operation of a pixel and a column ADC when n=12 and m=1 in the third embodiment.

FIG. 11 is a diagram illustrating the configuration of pixel and a column ADC of a fourth embodiment.

FIG. 12 is a diagram illustrating the configuration of a pixel and a column ADC of a fifth embodiment.

FIG. 13 is a timing chart of operation of a pixel and a column ADC when n=12, m=2, and k=1 in the fifth embodiment.

FIG. 14 is a diagram illustrating the configuration of a pixel and a column ADC of a sixth embodiment.

FIG, 15 is a diagram illustrating the configuration of a pixel and a column ADC of a seventh embodiment.

FIG. 16 is a diagram illustrating the characteristics of the reference example 2 and the third, fifth, seventh, and eighth embodiments.

FIG. 17 is a diagram illustrating the configuration of a pixel and a column ADC of a ninth embodiment.

FIG. 18 is a diagram illustrating the configuration of a successive-approximation-type conversion circuit.

FIG. 19 is a timing chart of operation of the pixel and the column ADC when n=12 and m=1 in the ninth embodiment.

FIG. 20 is a diagram illustrating the configuration of a pixel and a column ADC of a tenth embodiment.

FIG. 21 is a diagram illustrating the configuration of a pixel and a column ADC of an eleventh embodiment.

FIG. 22 is a diagram illustrating the configuration of a pixel and a column ADC of a twelfth embodiment.

### DETAILED DESCRIPTION

Hereinafter, embodiments will be described with reference to the drawings.

### First Embodiment

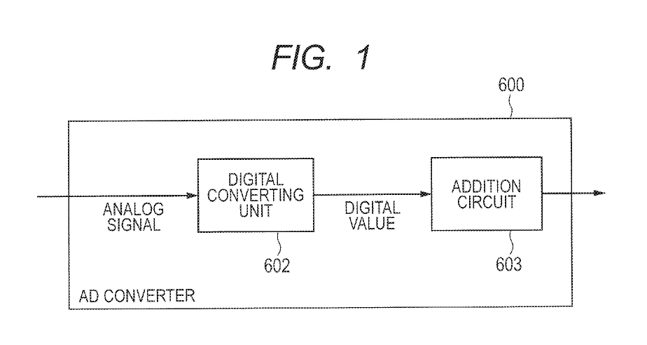

FIG. 1 is a diagram illustrating the configuration of an AD converter 600 of a first embodiment,

The AD converter 600 has a digital converting unit 602 and an addition circuit 60.

The AD converter 600 outputs n bits.

The digital converting unit 602 converts each of P pieces of analog signals of different times output from the same place to a digital value of (n−m) bits.

The addition circuit 603 integrates the P pieces of digital values converted.

n denotes a natural number of 1 or larger, m denotes a natural number of 1 or larger and less than n, and P denotes a natural number of 1 or larger and m or less.

As described above, according to the embodiment, in an AD converter of outputting n bits, P pieces of digital values converted to (n−m) bits are integrated, so that random noise included in an input analog signal and random noise which occurs in the process of the digital converting unit 602 can be suppressed. According to the embodiment, an analog signal obtained by imaging with low illumination can be amplified. According to the embodiment, without increasing the circuit scale, AD conversion time is not increased.

At the preceding stage of the addition circuit 603, an FPN (Finite Pattern Noise) correction unit may be provided. The FPN correction unit suppresses fixed pattern noise included in an output of the digital converting unit 602.

### General Configuration of Solid-State Image Sensing Device

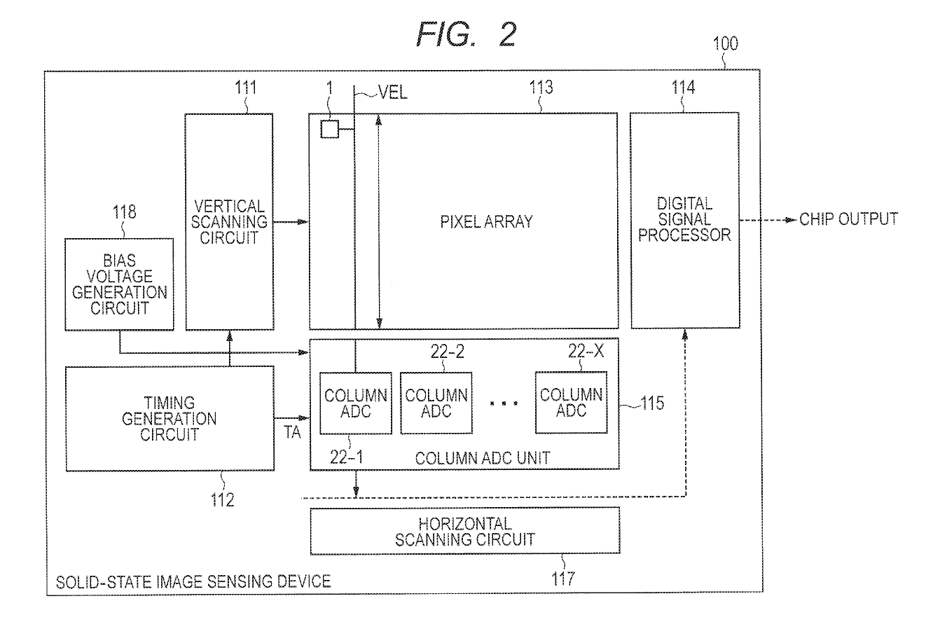

FIG. 2 is a diagram illustrating the configuration of a solid-state image sensing device 100.

The solid-state image sensing device 100 is a CMOS (Complementary Metal Oxide Semiconductor) image sensor and is comprised of a single semiconductor chip. The solid-state image sensing device 100 includes a pixel array 113, a vertical scanning circuit 111, a pixel signal read line VEL, a column ADC (Analog to Digital Converter) unit 115, a horizontal scanning circuit 117, a digital signal processor 114, a timing generation circuit 112, and a bias voltage generation circuit 118.

The pixel array 113 has a plurality of pixels 1 disposed in rows and columns. The pixel 1 stores charges of an amount according to a light reception amount. The pixel signal read line VEL is disposed in the vertical direction and coupled to the pixel 1.

The timing generation circuit 112 generates a timing signal TA controlling the operation timing of the pixel array 113 and circuits in the column ADC unit 115 and outputs it to the pixel array 113 and the column ADC unit 115.

The bias voltage generation circuit 118 generates various bias voltages and supplies them to the column ADC unit 115.

Voltage signals read from pixels in a row selected by the vertical scanning circuit 111 are subject to digital conversion by column ADCs 22-1 to 22-X in the column ADC unit 115. X denotes the number of columns in the pixel array 113. By sequentially selecting the column ADCs 22-i (i=1 to X) disposed every column by the horizontal scanning circuit 117, the digital-converted pixel signals are read by the digital signal processor 114 and, after that, output from the solid-state image sensing device 100.

### REFERENCE EXAMPLE 1

An AD converter included in the column ADC unit 115 will be described.

First, a reference example of an AD converter outputting n bits will be described.

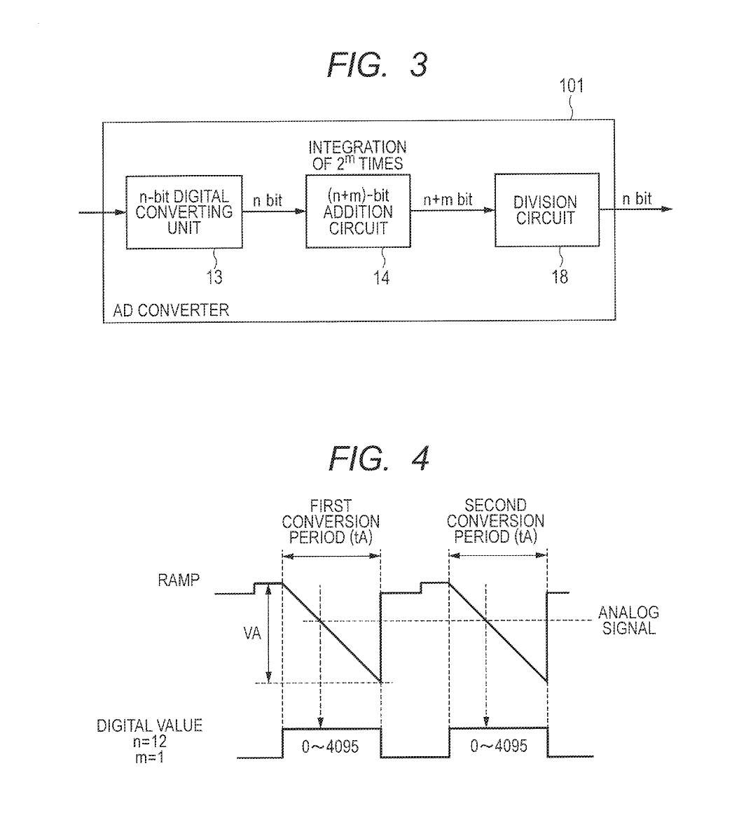

FIG. 3 is a diagram illustrating the configuration of an AD converter 101 of reference example 1.

The AD converter 101 has a digital converting unit 13 of n bits, an addition circuit 14 of (n+m) bits, and a division circuit 18.

The digital converting unit 13 converts an analog signal to digital data of n bits by comparing an input analog signal with a ramp signal RAMP as a reference signal. The digital converting unit 13 repeats the conversion 2^{m} times on analog signals of different times which are output from the same place.

The addition circuit 14 integrates the digital data output from the digital converting unit 13 2^{m} times. For example, when m=1, data of n bits output from the digital converting unit 13 is integrated twice, so that the number of bits of the addition circuit 14 becomes (n+1) bits.

The division circuit 18 divides the (n+m) bits output from the addition circuit 14 by 2^{m} to reset the bits to the n bits.

The results of conversion to digital signals of the plurality of times by the digital converting unit 13 are averaged by the addition circuit 14 and the division circuit 18, thereby reducing noise. In this case, the signal components are also averaged by the division circuit 18, so that the signal components cannot be amplified.

FIG. 4 is a timing chart of operation of the AD converter 101 of the reference example 1 when n=12 and m=1.

In each conversion period, the digital converting unit 13 compares the input analog signal with the ramp signal RAMP as a reference signal and outputs a digital value in the range of 0 to 4095. The length of each conversion period is set as tA. The digital converting unit 13 executes digital conversion twice.

An FPN correction unit may be provided at the preceding stage of the addition circuit 14. The FPN correction unite, suppresses fixed pattern noise included in an output of the digital converting unit 13.

### Second Embodiment

An AD converter 102 outputting n bits of a second embodiment will be described.

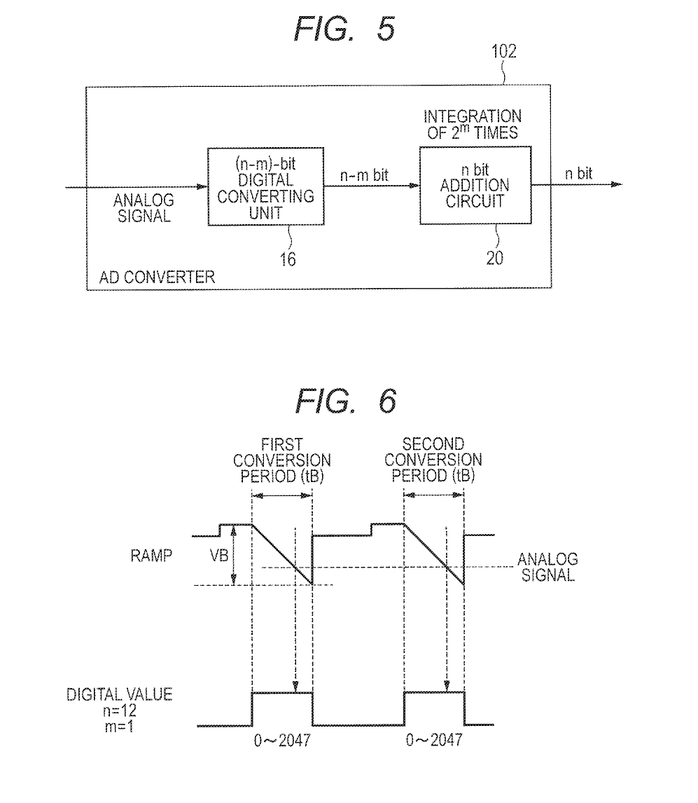

FIG. 5 is a diagram illustrating the configuration of the AD converter 102 of the second embodiment.

The AD converter 102 of the second embodiment has a digital converting unit. 16 of (n−m) bits and an addition circuit 20 of n bits. m denotes a natural number which is 1 or larger and less than n.

The digital converting unit 16 compares an input analog signal with the ramp signal RAMP as a reference signal, thereby converting the analog signal to digital data of (n−m) bits. The digital converting unit 16 repeats the conversion 2^{m} times or analog signals of different times output from the same place.

The addition circuit 20 integrates the digital data output from the digital converting unit 16 2^{m} times. For example, when m=1, data of (n−1) bits output from the digital converting unit 16 is integrated twice, so that the number of bits of the addition circuit 20 becomes n bits.

The conversion results to digital data of a plurality of times by the digital converting unit 16 are added by the addition circuit 17, thereby reducing noise.

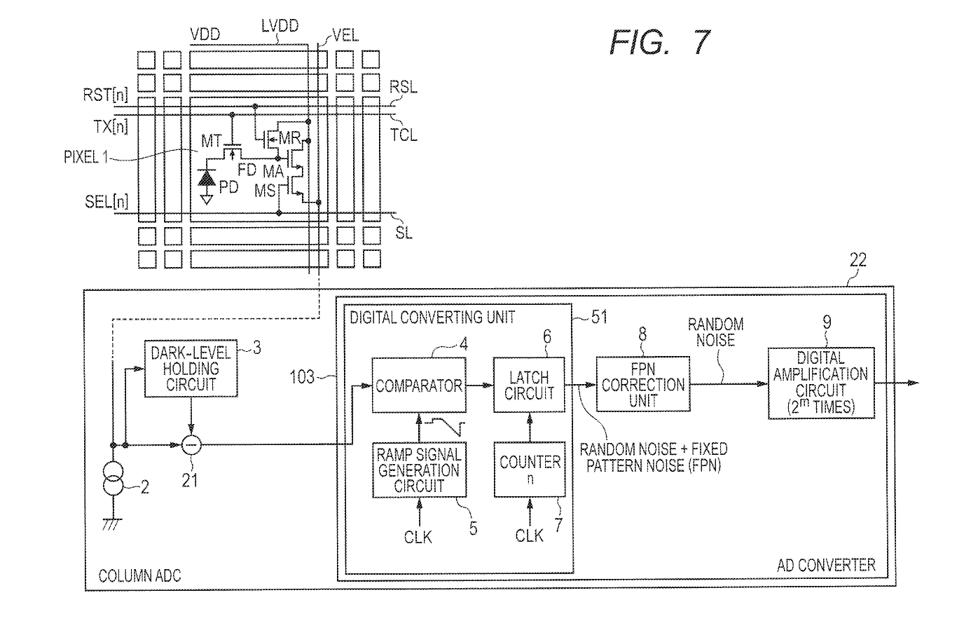

FIG. 6 is a timing chart of operation of the AD converter 102 of the second embodiment when n=12 and m=1.

In each conversion period, the digital converting unit 16 compares the input analog signal with the ramp signal RAMP as a reference signal and outputs a digital value in the range of 0 to 2047. The digital converting unit 16 has to execute the digital conversion of twice in a manner similar to the reference example 1.

However, the length of the conversion period of the second embodiment is tB which is about ½ of the length to of the conversion period in the reference example 1 for the following reason. The amplitude VB of the ramp signal RAMP as a reference signal is ½ of the amplitude VA of the ramp signal RAMP in the reference example 1, and an output of the digital converting unit 13 is set in the range of 0 to 2047 which is the half of that in the reference example 1. Consequently, an analog signal exceeding the range is converted to the maximum value 2047. Therefore, the AD converter of the embodiment is suitable for the use of converting a signal obtained with low illumination in short time at high precision.

In the reference example 1, an internal memory of (n+m) bits is necessary so that the addition circuit 14 stores an addition result. On the other hand, in the second embodiment, a memory of n bits is necessary so that the addition circuit 20 stores an addition result. The capacity of the memory in the AD converter 102 of the second embodiment can be made smaller than that of the AD converter 101 of the reference example 1.

An FPN correction unit may be provided at the preceding stage of the addition circuit 20. The FPN correction unit suppresses fixed pattern noise included in an output of the digital converting unit 16.

### REFERENCE EXAMPLE 2

FIG. 7 is a diagram illustrating the configuration of the pixel 1 and a column ADC 22 of reference example 2.

In FIG. 7, the pixel 1 in one column in the n-th row in the pixel array 113 is illustrated.

The pixel 1 includes a photodiode PD, a transfer transistor MT, a reset transistor MR, an amplification transistor MA, and a selection transistor MS.

The photodiode PD is a photoelectric conversion element which photoelectric-converts incident light to charges (in this case, electrons) of an amount according to the amount of the incident light and stores the charges.

A floating diffusion FD generates voltage corresponding to the charges accumulated in the photodiode PD. The transfer transistor MT is coupled between the photodiode PD and the floating diffusion FD.

The transfer transistor MT is comprised of an N-channel MOS transistor. The gate of the transfer transistor MT receives a transfer control signal TX output from the timing generation circuit 112 via a transfer control line TCL (the transfer transistor MT in the n-th row receives a transfer control signal TX [n]). When the transfer control signal TX becomes the high level, the transfer transistor MT transfers the charges accumulated in the photodiode PD to the floating diffusion FD.

The reset transistor MR is comprised of an N-channel MOS transistor. The reset transistor MR is coupled between a power supply line LVDD transmitting voltage VDD and the floating diffusion FD. The gate of the reset transistor MR receives a reset signal RST output from the timing generation circuit 112 via a reset control line RSL (the reset transistor MR in the n-th row receives a reset signal RST [n]). When the reset signal RST becomes the high the reset transistor MR resets the voltage of the floating diffusion FD to the voltage VDD of the power supply line LVDD.

The amplification transistor MA is comprised of an N-channel MOS transistor. The amplification transistor MA has a gate coupled to the floating diffusion FD, a drain coupled to the power supply line LVDD, and a source.

The selection transistor MS is comprised of an N-channel MOS transistor. The selection transistor MS is coupled between the source of the amplification transistor MA and the pixel signal read line VEL. The gate of the selection transistor MS receives a selection signal SEL output from the timing generation circuit 112 via a selection signal line SL (the selection transistor MS in the n-th row receives a selection signal SEL[n]).

A column ADC 22 has a current source 2, a dark level holding circuit 3, a subtractor 21, and arm AD converter 103.

The AD converter 103 is an integration-type AD converter. The AD converter 103 has a digital converting unit 51, an FPN correction unit 8, and a digital amplification circuit 9. The digital converting unit 51 has a ramp signal generation circuit 5, a comparator 4, a counter 7, and a latch circuit 6.

The current source 2 is coupled to the pixel 1 and supplies current to the pixel 1.

The dark-level holding circuit 3 samples and holds a signal of dark level sent from the pixel 1. The signal of dark level is a signal output from the pixel 1 before the voltage of the floating diffusion FD is reset to VDD and charges accumulated in the photodiode PD are transferred to the floating diffusion FD.

The subtractor 21 subtracts the signal of dark level held in the dark-level holding circuit 3 from the pixel signal output from the pixel 1. The pixel signal is a signal output from the pixel 1 after the charges accumulated in the photodiode PD are transferred to the floating diffusion FD. By correlation double sampling using the difference between the pixel signal and the signal of dark level, reset noise is eliminated.

The ramp signal generation circuit 5 generates the ramp signal RAMP having a saw-tooth shape. In a conversion period, the ramp signal generation circuit 5 decreases the magnitude of the ramp signal RAMP only by a predetermined amount ΔV at the timing of the rising edge of a reference clock CLK in a predetermined amplification range VA (0 or larger and MAX1 or less). The amplification range VA is a range according to the number of bits of the counter 7. The ramp signal RAMP becomes smaller step by step with time from the maximum voltage MAX1 to the minimum voltage (=0). The ramp signal generation circuit 5 starts the decrease from the maximum voltage MAX1 of the ramp signal RAMP in accordance with the timing signal TA output from the timing generation circuit 112.

The counter 7 increments the counter value at the timing of the rising edge of the reference clock CLK in the conversion period. The counter 7 outputs the counter value to the latch circuit 6. The counter 7 resets the count value to 0 in accordance with the timing signal TA output from the timing generation circuit 112, and starts counting up.

The counter 7 is an n-bit counter. In the decrease period of the ramp signal RAMP, the counter 7 increments the counter value from 0 to 2ⁿ−1. At the start of the decrease period of the ramp signal RAMP, the value of the counter 7 is 0. At the end of the decrease period of the ramp signal RAMP, the value of the counter 7 is 2ⁿ−1. Updating of the counter value of the counter 7 and changing of the ramp signal RAMP synchronize with the reference clock CLK. Therefore, synchronously with the change in the magnitude of the ramp signal RAMP, the counter value is updated. In the case where n=12, the counter value lies in the range of 0 to 4095.

The comparator 4 compares the difference signal between the pixel signal and the dark-level signal sent from the subtractor 21 and the reference signal RAMP. When the magnitude of the signal sent from the subtractor 21 is larger than that of the reference signal RAMP, the comparator 4 outputs a high-level signal. When the magnitude of the signal sent from the subtractor 21 is equal to or smaller than that of the reference signal RAMP, the comparator 4 outputs a low-level signal.

When the level of the signal output from the comparator 4 changes from the high level to the low level, the latch circuit 6 fetches and holds a counter value output from the counter 7.

The FPN (Finite Pattern Noise) correction unit 8 eliminates fixed pattern noise included in the output of the latch circuit 6.

The digital amplification circuit 9 amplifies the signal output from the FPN correction unit 8 by 2^{m} times and outputs the resultant to the outside of the column ADC 22. m denotes a natural number of 1 or larger. Consequently, data of (n+m) bits is output from the column ADC 22. By increasing the gain of the output by the digital amplification circuit 9, a subject can be recognized even in a dark place.

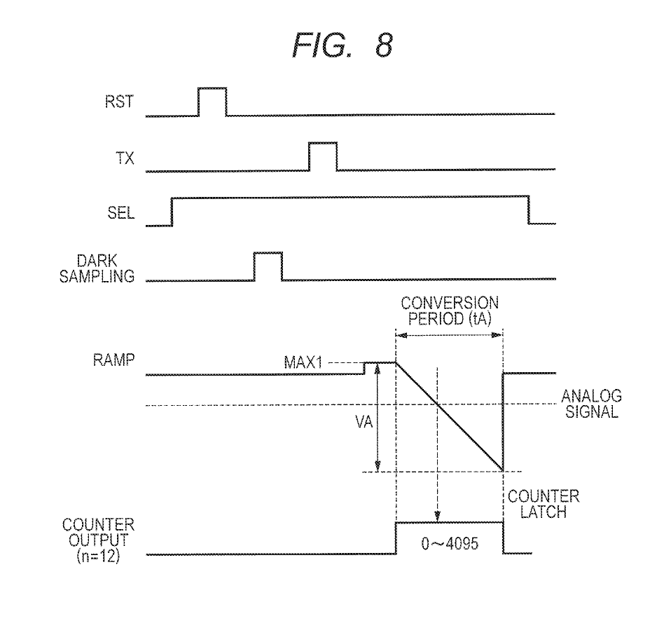

FIG. 8 is a timing chart of operation of the pixel 1 and the column ADC 22 when n=12 in Reference Example 2.

First, correlation double sampling is performed. The pixel 1 is selected by the selection signal SEL, and the potential of the floating diffusion PD is reset by the reset signal RST. The voltage applied to a pixel signal read line VEL on the basis of the potential of the floating diffusion FD at this time is held in the dark-level holding circuit 3 as a dark-level signal from the pixel 1. Subsequently, by a transfer control signal TX, electrons generated by the photoelectric conversion by the photodiode PD are transferred to the floating diffusion FD. The voltage applied to the pixel signal read line VEL on the basis of the potential of the floating diffusion FD at this time is a signal output from the pixel 1 as a pixel signal from the pixel 1. The subtractor 21 calculates the difference between the pixel signal and the signal of dark level held in the dark-level holding circuit 3 and sends it to the comparator 4.

In the conversion period, the following is executed.

According to the timing signal TA output from the timing generation circuit 112, the ramp signal generation circuit 5 starts generation of the ramp signal RAMP, and the counter 7 starts counting up.

The ramp signal generation circuit 5 sets the maximum voltage MAX1 as the start voltage, sets the minimum voltage (=0) as the end voltage, and generates the ramp signal RAMP which decreases by the predetermined amount ΔV at the timing of the rising edge of the reference clock CLK.

A counter 17 increments the counter value at the timing of the rising edge of the reference clock CLK in the range of 0 to 4095.

When the magnitude of an analog signal sent from the subtractor 21 is larger than that of the reference signal RAMP, the comparator 4 outputs a signal of the high level. When the magnitude of the analog signal sent from the subtractor 21 is equal to or smaller than that of the reference signal RAMP, the comparator 4 outputs a signal of the low level.

When the level of the signal output from the comparator 1 changes from the high level to the low level, the latch circuit 6 fetches and holds the counter value output from the counter 7.

An output of the latch circuit 6 includes a random noise component and a fixed pattern noise component. Although the fixed pattern noise is eliminated by the FPN correction unit 8, the random noise component is transmitted to the digital amplification circuit 9 without being suppressed.

The digital amplification circuit 9 amplifies a signal output from the FPN correction unit 8 by 2^{m} times and outputs the resultant to the outside of the column ADC 22. By the operation, a problem occurs that not only the signal component but also the random noise component are amplified to the magnitude of the 2^{m} times.

### Third Embodiment

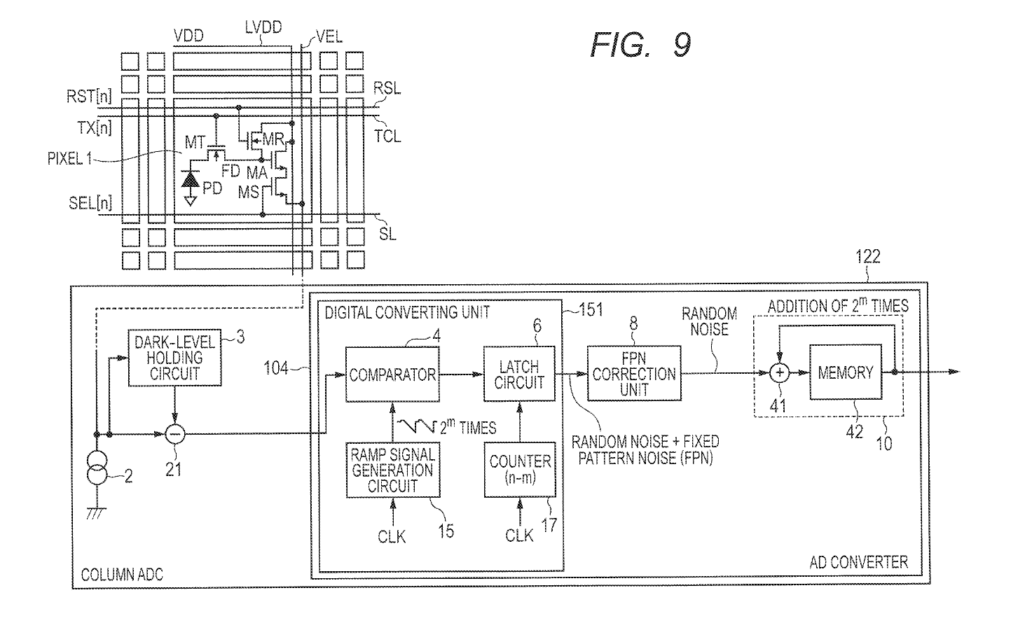

FIG. 9 is a diagram illustrating the configuration of the pixel 1 and a column ADC 122 of a third embodiment.

In FIG. 9, the pixel 1 in one column in the n-th row in the pixel array 113 is illustrated.

The points that the configuration of FIG. 9 is different from that of FIG. 7 are as follows.

Like the reference example 1, the ramp signal generation circuit 15 generates the ramp signal RAMP of a saw tooth shape. In the conversion period, the ramp signal generation circuit 15 decreases the magnitude of the ramp signal RAMP only by the predetermined amount ΔV at the timing of the rising edge of the reference clock CLK in a predetermined range VB (0 or larger and MAX2 (=MAX1/2^{m}) or less). The amplification range VB is a range according to the number of bits of the counter 17. The ramp signal RAMP becomes smaller step by step with time from the maximum voltage MAX2 to the minimum voltage (=0). m denotes a natural number which is 1 or larger and less than n. When the timing signal TA output from the timing generation circuit 112 is received, the ramp signal generation circuit 15 starts the decrease from the maximum voltage MAX2 of the ramp signal RAMP. The ramp signal generation circuit 15 generates the ramp signal RAMP 2^{m} times for the selected pixel 1. That is, the ramp signal generation circuit 15 receives the timing signal TA 2^{m} times for one pixel. In the case where m=1, the maximum voltage of the ramp signal RAMP is MAX1/2, and the ramp signal RAMP is generated twice.

The counter 17 increments the counter value at the timing of the rising edge of the reference clock CLK in the conversion per The counter 17 outputs the counter value to the latch circuit 6. The counter 17 resets the count value to 0 in accordance with the timing signal TA output from the timing generation circuit 112 and starts counting up. The counter 17 executes the counting operation 2^{m} times for the selected pixel 1. That is, the counter 17 receives the timing signal TA 2^{m} times for one pixel.

In the case where the column ADC 122 outputs n bits, the counter 17 is an (n−m)-bit counter. In the decrease period of the ramp signal RAMP, the counter 17 increases the counter value in the range of 0 to 2^{n-m}−1. At the start of the decrease period of the ramp signal RAMP, the value of the counter 17 is 0. At the end of the decrease period of the ramp signal RAMP, the value of the counter 17 is 2^{n-m}−1. Updating of the counter value of the counter 17 and changing of the ramp signal RAMP synchronize with the reference clock CLK. Therefore, synchronously with the change in the magnitude of the ramp signal. RAMP, the counter value is updated. In the case where n=12 and m=1, the counter value lies in the range of 0 to 2047.

The AD converter 104 has an addition circuit 10 in place of the digital amplification circuit 9. The addition circuit 10 integrates 2^{m} pieces of counter values ((n−m) bits) from which fixed noise is eliminated by the FPN correction unit 8 and outputs n bits. The addition circuit 10 has an adder 41 and a memory 42.

By the addition circuit 10, in comparison to the case where there is no addition circuit 10, random noise which occurs from an output (source follower) of the pixel 1 to an output of the column ADC 122 becomes √2^{m} times, and a signal component becomes 2^{m} times. Therefore, the S/N ratio becomes √2^{m} times. The number of bits output from the column ADO 122 is n bits like in the reference example 1.

In the reference example 2, since the digital amplification circuit 9 multiplies an input signal by 2^{m} times, an output signal does not become an odd-number value, and resolution decreases. On the other hand, there are cases that an output of the addition circuit 10 becomes an odd-number value, so that decrease in the resolution like in the reference example 2 does not occur, and the picture quality improves.

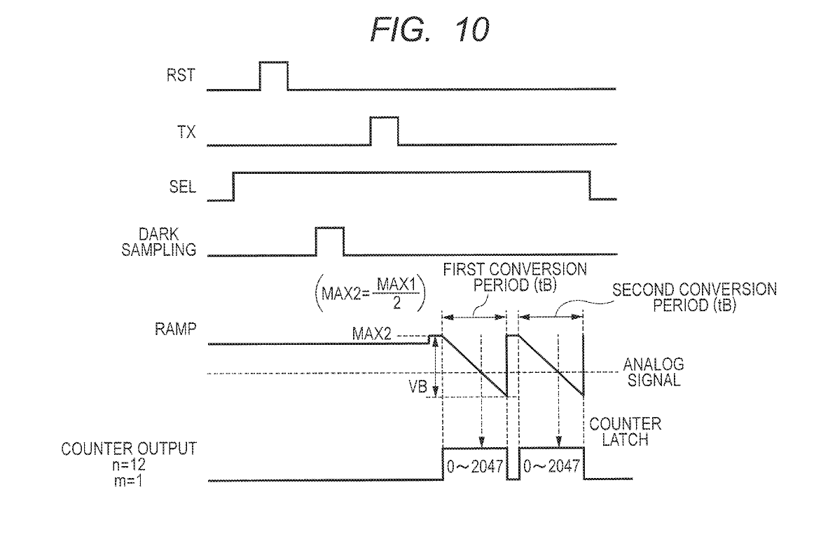

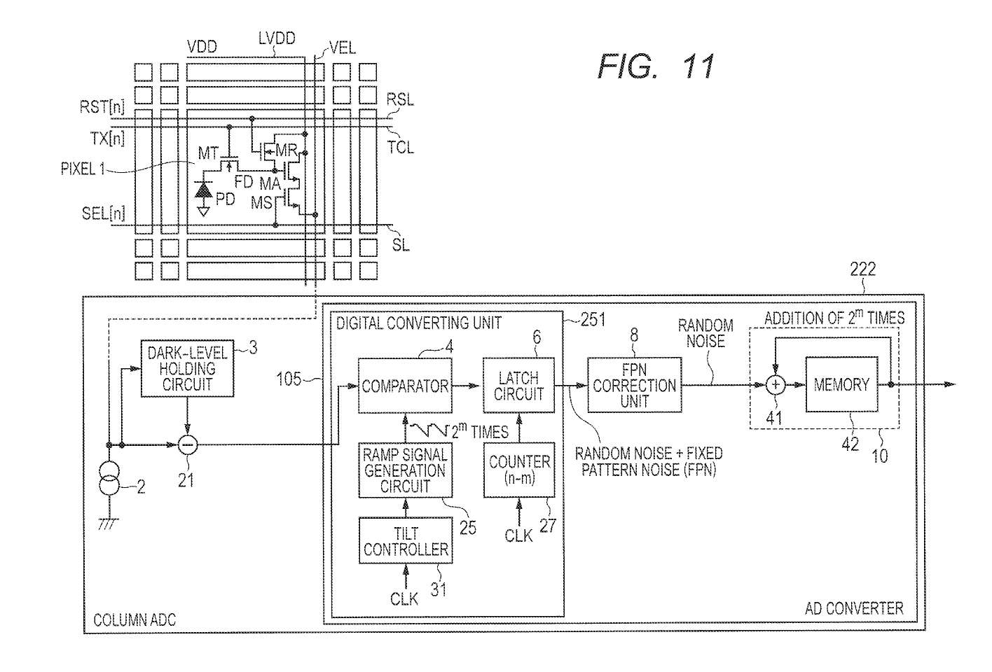

FIG. 10 is a timing chart of operation of the pixel 1 and the column ADC 122 when n=12 and m=1 in the third embodiment.

In a manner similar to the reference example 2, correlation double sampling is performed.

In a first conversion period, the following is executed.

According to a timing signal TA1 output from the timing generation circuit 112, the ramp signal generation circuit 15 starts generating the ramp signal RAMP, and the counter 17 starts counting up.

The ramp signal generation circuit 15 sets maximum voltage MAX1/2 as start voltage, sets minimum voltage (=0) as end voltage, and generates the ramp signal RAMP which becomes smaller by the predetermined amount ΔV at the timing of the rising edge of the reference clock CLK.

The counter 17 increments the counter value at the timing of the rising edge of the reference clock CLK in the range of 0 to 2047.

When the magnitude of a signal sent from the subtractor 21 is larger than that of the reference signal RAMP, the comparator 4 outputs a signal of the high level. When the magnitude of the signal sent from the subtractor 21 is equal to or smaller than that of the reference signal RAMP, the comparator 4 outputs a signal of the low level.

When the level of the signal output from the comparator 4 changes from the high level to the low level, the latch circuit 6 fetches and holds the counter value output from the counter 7.

The FPN correction unit 8 eliminates fixed noise in the signal output from the latch circuit 6.

The addition circuit 10 adds the initial value 0 held in the memory 42 and the count value from which the fixed noise is eliminated and which is output from the FPN correction unit 8, and holds the resultant in the memory 42.

In a second conversion period, like in the first conversion period, the ramp signal generation circuit 15, the counter 17, the comparator 4, the latch circuit 6, and the FPN correction unit 8 operate.

The addition circuit 10 adds the counter value of the previous time held in the memory 42 and the count value from which the fixed noise is eliminated and which is output from the FPN correction unit 8 and holds the resultant in the memory 42. From the memory 42, the addition result is output.

When m=1 as in the above-described example, in the embodiment, in comparison to the reference example 2, the amplitude of the ramp signal RAMP can be set to ½, and the range of the counter value can be set to ½. Consequently, length tB of the conversion period can be set to about ½ of length tA of the conversion period of the reference example 2. As a result, AD conversion can be performed twice without changing the time of reading one pixel (that is, time since reading of a signal from a pixel until output of data to the outside of a solid-state image sensing device) so that the frame rate can be maintained.

As described above, in the embodiment, random noise can be lessened and the gain of 2^{m} times can be realized. Without deteriorating the frame rate, the S/N ratio can be increased by √2^{m} times, and the resolution can be prevented from decreasing. Further, it is sufficient to just add the addition circuit to the AD converter. Since the number of output bits of the AD converter is n bits like in the reference example 1, increase in the circuit scale is small.

### Fourth Embodiment

FIG. 11 is a diagram illustrating the configuration of the pixel 1 and a column ADC 222 of a fourth embodiment.

The column ADC 222 of the fourth embodiment is different from the column ADC 122 of the third embodiment with respect to the point that a digital converting unit 251 included in the column ADC 222 of the fourth embodiment has a ramp signal generation circuit 25 capable of changing the tilt of a ramp signal and a tilt controller 31 controlling the tilt of a ramp signal.

The tilt controller 31 controls the tilt of the ramp signal RAMP generated by the ramp signal generation circuit 25.

For example, the tilt controller 31 instructs the ramp signal generation circuit 25 to set the tilt of the ramp signal CAMP to 1/A. In the conversion period, the ramp signal generation circuit 25 decreases the magnitude of the ramp signal RAMP only by the predetermined amount ΔV/A at the timing of the rising edge of the reference clock CLK in a predetermined amplitude range VB (0 or larger and MAX2 (=MAX1/2^{m}) or less).

According to the setting of the tilt of the ramp signal RAMP to 1/A, the number of bits of a counter 27 has to be increased. For example, according to a setting of the tilt of the ramp signal RAMP to 1/2^{m}, it is sufficient to increase the number of bits of the counter 27 only by r. In other words, it is sufficient to adjust the amplitude and the tilt of the ramp signal RAMP in accordance with the number of bits of the counter 27.

In the embodiment, the value of the counter latched by the latch circuit 6 is A times as large as that of the third embodiment. Therefore, an output of the column ADC can be increased by A times. In the embodiment, the gain can be increased by A times as compared with that of the third embodiment.

### Fifth Embodiment

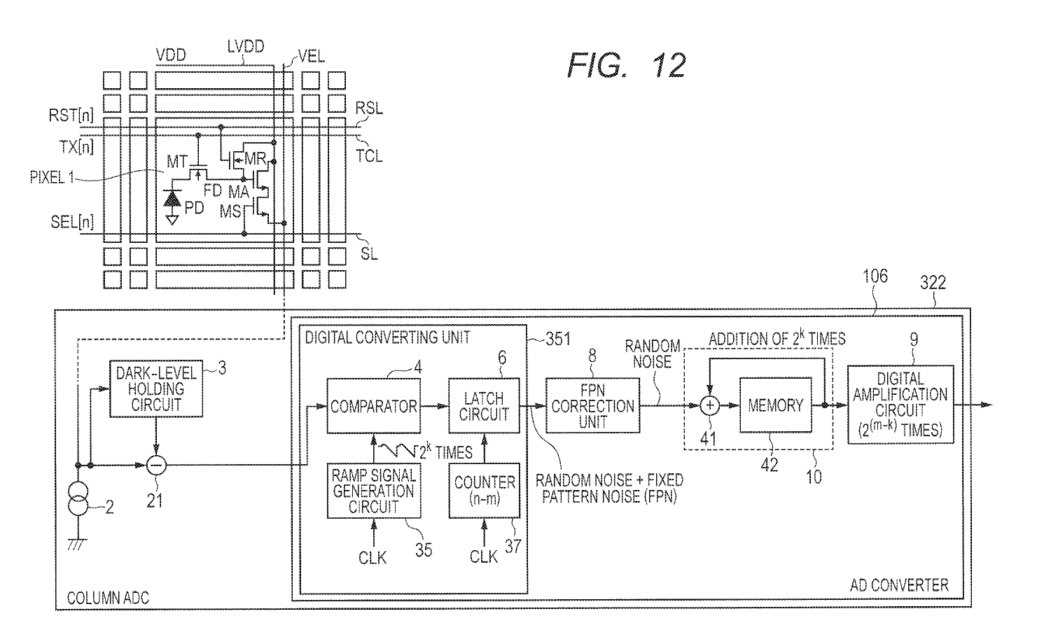

FIG. 12 is a diagram illustrating the configuration of the pixel 1 and a column ADC 322 of a fifth embodiment.

The column ADC 322 of the fifth embodiment is different from the column ADC 222 of the fourth embodiment with respect to the point that the digital amplification circuit 9 is provided at the post stage of the addition circuit 10.

Between the i-th conversion period and the (i+1)th conversion period, time Δt to increase the ramp signal RAMP from bottom is necessary. When m increases, the sum (m×Δt) of the time increases to an unignorable degree, so that all of digital conversion of 2^{m} times and addition of 2^{m} times cannot be executed within the time of reading one pixel. In the fifth embodiment, such a problem is solved.

The ramp signal generation circuit 35 generates the ramp signal RAMP of a saw-tooth shape in a manner similar to the third embodiment. In the conversion period, the ramp signal generation circuit 35 decreases the magnitude of the ramp signal RAMP only by the predetermined amount ΔV at the timing of the rising edge of the reference clock CLK in a predetermined amplitude range VC (0 or larger and MAX3 (=MAX1/2^{m}) or less). The amplitude range VC is a range according to the number of bits of a counter 37. The ramp signal RAMP becomes smaller step by step with time from the maximum voltage MAX3 to the minimum voltage (=0). m denotes a natural number which is 1 or larger and less than n. When the timing signal TA output from the timing generation circuit 112 is received, the ramp signal generation circuit 35 starts the decrease from the maximum voltage MAX3 of the ramp signal RAMP. The ramp signal generation circuit 35 generates the ramp signal RAMP 2^{k} times for the selected pixel 1. That is, the ramp signal generation circuit 35 receives the timing signals TA 2^{k} times for one pixel. k denotes a natural number and m>k is satisfied. In the case where m=2 and k=1, the maximum voltage of the ramp signal RAMP is MAX1/4, and the ramp signal RAMP is generated twice.

The counter 37 increments the counter value at the timing of the rising edge of the reference clock CLK in the conversion period. The counter 37 outputs the counter value to the latch circuit 6. The counter 37 resets the count value to 0 in accordance with the timing signal TA output from the timing generation circuit 112 and starts counting up. The counter 37 executes the counting operation 2^{k} times for the selected pixel 1. That is, the counter 37 receives the timing signal TA 2^{k} times for one pixel.

In the case where the column ADC 322 outputs n bits, the counter 37 is an (n−m)-bit counter. In the decrease period of the ramp signal RAMP, the counter 37 increases the counter value in the range of 0 to 2^{n-m}−1. At the start of the decrease period of the ramp signal RAMP, the value of the counter 37 is 0. At the end of the decrease period of the ramp signal RAMP, the value of the counter 37 is 2^{n-m}−1. Updating of the counter value of the counter 37 and changing of the ramp signal RAMP synchronize with the reference clock CLK. Therefore, synchronously with the change in the magnitude of the ramp signal. RAMP, the counter value is updated. In the case where n=12 and m=2, the counter value lies in the range of 0 to 1023.

The addition circuit 10 integrates 2^{k} pieces of counter values ((n−m) bits) from which fixed noise is eliminated by the FPN correction unit 8 and outputs (n−m+k) bits.

The digital amplification circuit 9 generates data of n bits by multiplying data of (n−m+k) bits output from the addition circuit 10 2^{m-k} k times, and outputs the data to the outside of the column ADC 322.

By the addition circuit 10 and the digital amplification circuit 9, in comparison to the case where there is no addition circuit 10 and no digital amplification circuit 9, random noise which occurs from an output (source follower) of the pixel 1 to an output of the column ADC 232 becomes 2^{m}/√2^{k} times, and a signal component becomes 2^{m} times. Therefore, the S/N ratio becomes √2^{k} times. The number of bits output from the column ADC 322 is n bits like in the reference example 1.

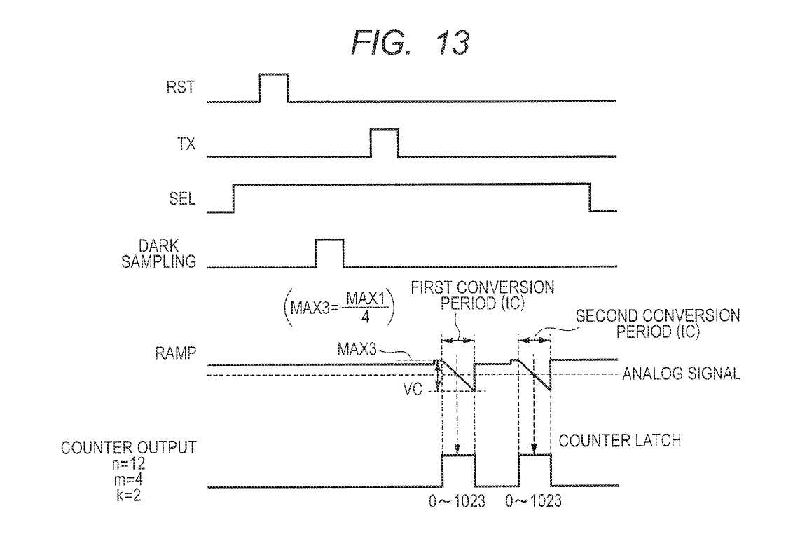

FIG. 13 is a timing chart of operation of the pixel 1 and the column ADC 322 when n=12, m=2, and k=1 in the fifth embodiment.

In a manner similar to the reference example 2, correlation double sampling is performed.

In a first conversion period, the following is executed.

According to the timing signal TA1 output from the timing generation circuit 112, the ramp signal generation circuit 35 starts generating the ramp signal RAMP, and the counter 37 starts counting up.

The ramp signal generation circuit 35 sets maximum voltage MAX1/4 as start voltage, sets minimum voltage (=0) as end voltage, and generates the ramp signal RAMP which becomes smaller by the predetermined amount ΔV at the timing of the rising edge of the reference clock CLK.

The counter 17 increments the counter value at the timing of the rising edge of the reference clock CLK in the range of 0 to 1023.

When the magnitude of a signal sent from the subtractor 21 is larger than that of the reference signal RAMP, the comparator 4 outputs a signal of the high level. When the magnitude of the signal sent from the subtractor 21 is equal to or smaller than that of the reference signal RAMP, the comparator 4 outputs a signal of the low level.

When the level of the signal output from the comparator 4 changes from the high level to the low level, the latch circuit 6 fetches and holds the counter value output from the counter 7

The FPN correction unit 8 eliminates fixed noise in the signal output from the latch circuit 6.

The addition circuit 10 adds the initial value 0 held in the memory 42 and the count value from which the fixed noise is eliminated and which is output from the FPN correction unit 8, and holds the resultant in the memory 42.

In a second conversion period, like in the first conversion period, a ramp signal generation circuit 35, the counter 37, the comparator 4, the latch circuit 6, and the PPM correction unit 8 operate.

The addition circuit 10 adds the counter value of the previous time held in the memory 42 and the count value from which the fixed noise is eliminated and which is output from the PPM correction unit 8 and holds the resultant in the memory 42. From the memory 42, the addition result of (n−m+k) bits is output.

The digital amplification circuit 9 generates data of n bits by multiplying the data of (n−m+k) bits output from the addition circuit 10 2^{m-k} times, and outputs it to the outside of the column ADC 322.

When m=2 and k=1 as in the above-described example, in the embodiment, in comparison to the reference example 2, the amplitude of the ramp signal RAMP can be set to ¼. Consequently, length tc of the conversion period can be set to about ¼ of the length tA of the conversion period of the reference example 2. As a result, AD conversion can be performed twice without changing the time of reading one pixel (that is, time since reading of a signal from a pixel until output of data to the outside of the solid-state image sensing device), so that the frame rate can be maintained.

In the fifth embodiment, by combining digital conversion and digital amplification, time margin of the AD converting operation can be increased, so that the number of times of AD conversions can be increased. Also in the fifth embodiment, like in the third embodiment, random noise can be lessened and the resolution can be prevented from decreasing and, in addition, the gain of 2^{m} times can be realized.

### Sixth Embodiment

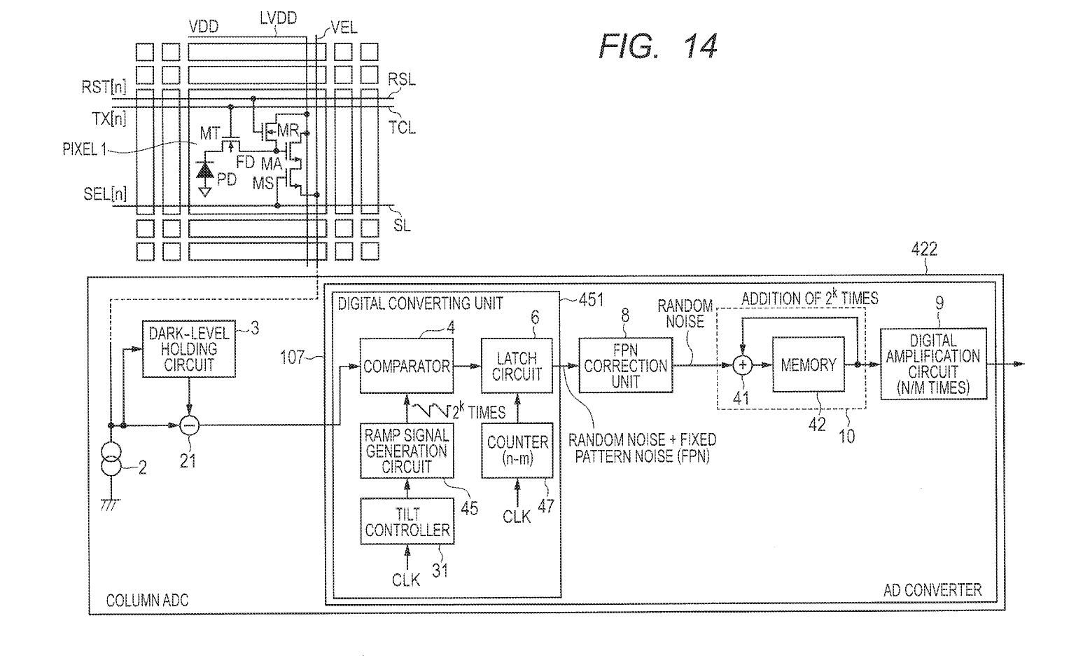

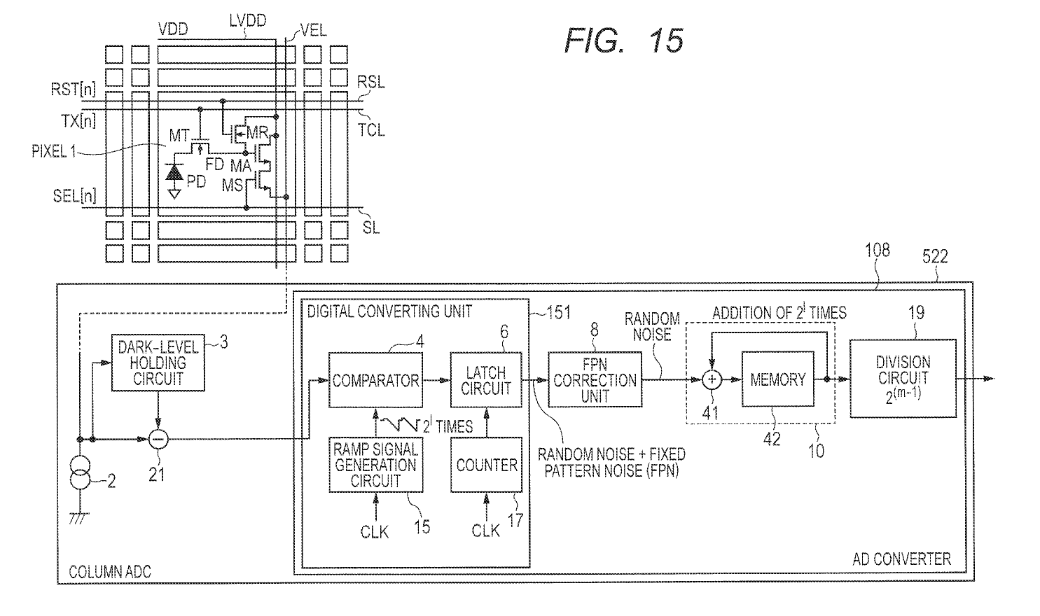

FIG. 14 is a diagram illustrating the configuration of the pixel 1 and a column ADC 422 of a sixth embodiment.

The column ADC 422 of the sixth embodiment is different from the column ADC 322 of the fifth embodiment with respect to the point that a digital converting unit 451 included in the column ADC 422 of the sixth embodiment has a ramp signal generation circuit 45 capable of changing the tilt of a ramp signal and the tilt controller 31 controlling the tilt of a ramp signal.

The tilt controller 31 controls the tilt of the ramp signal RAMP generated by the ramp signal generation circuit 45.

For example, the tilt controller 31 instructs the ramp signal generation circuit 45 to set the tilt of the ramp signal RAMP to 1/A. In the conversion period, the ramp signal generation circuit 45 decreases the magnitude of the ramp signal RAMP only by the predetermined amount ΔV/A at the timing: of the rising edge of the reference clock CLK in a predetermined amplitude range VC (0 or larger and MAX2 (=MAX1/2^{m}) or less).

According to the setting of the tilt of the ramp signal RAMP to 1/A, the number of bits of a counter 47 has to be also increased. For example, according to a setting of the tilt of the ramp signal RAMP to 1/2^{r}, it is sufficient to increase the number of bits of the counter 17 only by r. In other words, it is sufficient to adjust the amplitude and the tilt of the ramp signal RAMP in accordance with the number of bits of the counter 47.

In the embodiment, the value of the counter latched by the latch circuit 6 is A times as large as that of the fifth embodiment. Therefore, an output of the column ADC can be increased by A times. In the embodiment, the gain can be increased by A times as compared with that of the fourth embodiment.

### Seventh Embodiment

FIG. 15 is a diagram illustrating the configuration of the pixel 1 and a column ADC 522 of a seventh embodiment.

The column ADC 522 of the seventh embodiment is different from the column ADC 222 of the third embodiment with respect to the point that a division circuit 19 is provided at the post stage of the addition circuit 10.

In the following, n denotes a natural number of 1 or larger, j denotes a natural number of 2 or larger and less than n, and m denotes a natural number of 1 or larger and less than j.

In a manner similar to the third embodiment, the ramp signal generation circuit 15 generates the ramp signal RAMP of a saw tooth shape. In the conversion period, the ramp signal generation circuit 15 decreases the magnitude of the ramp signal RAMP only by the predetermined amount ΔV at the timing of the rising edge of the reference clock CLK in a predetermined range VD (0 or larger and MAX4 (=MAX1/2^{j}) or less). The ramp signal RAMP becomes smaller step by step with time from the maximum voltage MAX4 to the minimum voltage (=0). When the timing signal TA output from the timing generation circuit 112 is received, the ramp signal generation circuit 15 starts the decrease from the maximum voltage MAX4 of the ramp signal RAMP. The ramp signal generation circuit 15 generates the ramp signal RAMP 2^{j} times for the selected pixel 1. That is, the ramp signal generation circuit 15 receives the timing signal TA 2^{j} times for one pixel. In the case where j=2, the maximum voltage of the ramp signal RAMP is MAX1/4, and the ramp signal RAMP is generated four times.

The counter 17 increments the counter value at the timing of the rising edge of the reference clock CLK in the conversion period. The counter 17 outputs the counter value to the latch circuit 6. The counter 17 resets the count value to 0 in accordance with the timing signal TA output from the timing generation circuit 112 and starts counting up. The counter 17 executes the counting operation 2^{j} times for the selected pixel 1. That is, the counter 17 receives the timing signal TA 2^{j} times for one pixel.

The counter 17 is an (n−j)-bit counter. In the decrease period of the ramp signal RAMP, the counter 17 increases the counter value in the range of 0 to 2^{n-j}−1. At the start of the decrease period of the ramp signal RAMP, the value of the counter 17 is 0. At the end of the decrease period of the ramp signal RAMP, the value of the counter 17 is 2^{n-j}−1. Updating of the counter value of the counter 17 and changing of the magnitude of the ramp signal RAMP synchronize with the reference clock CLK. Therefore, synchronously with the change in the magnitude of the ramp signal RAMP, the counter value is updated. In the case where n=12 and j=2, the counter value lies in the range of 0 to 1023.

The addition circuit 10 integrates 2^{j} pieces of counter values ((n−j) bits) from which fixed noise is eliminated by the FPN correction unit 8 and outputs n bits.

The division circuit 19 attenuates the data of n bits output from the addition circuit 10 by 1/2^{j-m} in times, thereby outputting data of (n+m−j) bits. In this case, m<j is satisfied.

When n=12, j=2, and m=1, the division circuit 19 attenuates the data of 12 bits by ½ time, thereby outputting data of 11 bits. The S/N ratio is √2^{j} times. In the embodiment, the number of output bits is reduced to (n+m−j) bits. However, the range of the counter values and the amplitude of the ramp signal RAMP are decreases only by the same amount of the number of integration times, so that the frame rate can be prevented from decreasing.

### Eighth Embodiment

An eighth embodiment is different from the seventh embodiment with respect to the range of counter values.

In the following, n denotes a natural number of 1 or larger, j denotes a natural number of 2 or larger and less than n, and m denotes a natural number of 1 or larger and less than j.

In a manner similar to the third embodiment, the ramp signal generation circuit 15 generates the ramp signal RAMP of a saw tooth shape. In the conversion period, the ramp signal generation circuit 15 decreases the magnitude of the ramp signal RAMP only by the predetermined amount ΔV at the timing of the rising edge of the reference clock CLK in a predetermined range VE (0 or larger and MAX5 (=MAX1/2^{m}) or less). The ramp signal RAMP becomes smaller step by step with time from the maximum voltage MAX5 to the minimum voltage (=0). When the timing signal TA output from the timing generation circuit 112 is received, the ramp signal generation circuit 15 starts the decrease from the maximum voltage MAX4 of the ramp signal RAMP. The ramp signal generation circuit 15 generates the ramp signal RAMP 2^{j} times for the selected pixel 1. That is, the ramp signal generation circuit 15 receives the timing signal TA 2^{j} times for one pixel. In the case where m=1 and j=2, the maximum voltage of the ramp signal RAMP is MAX1/2, and the ramp signal RAMP is generated four times.

The counter 17 increments the counter value at the timing of the rising edge of the reference clock CLK in the conversion period. The counter 17 outputs the counter value to the latch circuit 6. The counter 17 resets the count value to 0 in accordance with the timing signal TA output from the timing generation circuit 112 and starts counting up. The counter 17 executes the counting operation 2^{j} times for the selected pixel 1. That is, the counter 17 receives the timing signal TA 21 times for one pixel.

The counter 17 is an (n−m)-bit counter. In the decrease period of the ramp signal RAMP, the counter 17 increases the counter value in the range of 0 to 2^{n-m}−1. At the start of the decrease period of the ramp signal RAMP, the value of the counter 17 is 0. At the end of the decrease period of the ramp signal RAMP, the value of the counter 17 is 2^{-m}−1. Updating of the counter value of the counter 17 and changing of the ramp signal RAMP synchronize with the reference clock CLK. Therefore, synchronously with the change in the magnitude of the ramp signal RAMP, the counter value is updated. In the case where n=12, j=2, and m=1, the counter value lies in the range of 0 to 2047.

The addition circuit 10 integrates 2^{j} pieces of counter values ((n−m) bits) from which fixed noise is eliminated by the PPM correction unit 8 and outputs (n+j−m) bits.

The division circuit 19 attenuates the data of (n+j−m) bits output from the addition circuit 10 to 1/2^{j-m} time, thereby outputting data of n bits.

When n=12, j=2, and m=1, the division circuit 19 attenuates the data of 13 bits to 1/2 time, thereby outputting data of 12 bits. The S/N ratio is √2^{j} times. In the embodiment, the number of output bits maintains at n bits. How ever, since the range of the counter values and the amplitude of the ramp signal RAMP are not decreased only by the same number as the number of times of integration, there is the possibility that the frame rate decreases.

### Comparison

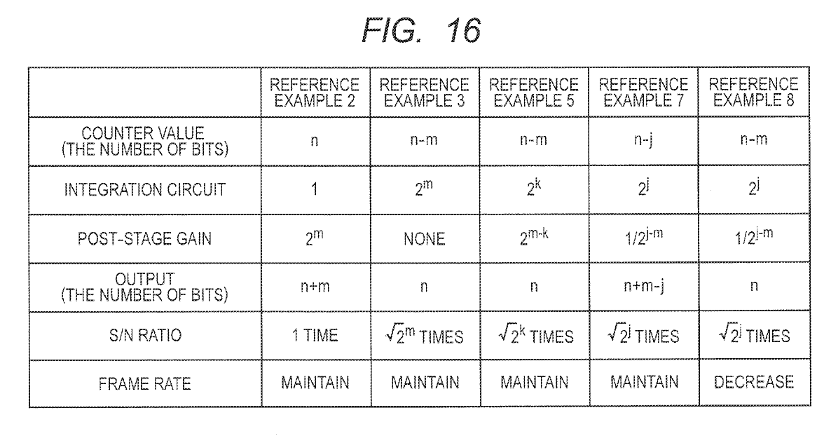

FIG. 16 is a diagram illustrating the characteristics of the reference example 2 and the third, fifth, seventh, and eighth embodiments.

In FIG. 16, the number of bits of the counter, the number of times of integration in the addition circuit, the gain in the post stage, the number of bits of digital data output from the column ADC, the S/N ratio, and the frame rate are illustrated. The relations k<m and j>m are satisfied. In the reference example 2 and the fifth embodiment, the gain increases by the digital amplification circuit in the post stage of the addition circuit. In the seventh and eighth embodiments, the gain decreases by the division circuit n the post stage of the addition circuit.

As illustrated in FIG. 16, in the seventh embodiment, the number of bits which are output decreases. In the eighth embodiment, the frame rate cannot be maintained. On the other hand, the third and fifth embodiments have an advantage that the number of output bits and the frame rate are maintained.

### Ninth Embodiment

In the third to eighth embodiments, the solid-state image sensing device including the integration-type AD converter has been described. The method of converting an analog signal to digital data a plurality of times and integrating the resultant to improve the S/N ratio can be applied also to a solid-state image sensing device including an AD converter of any other kind. In a ninth embodiment, a solid-state image sensing device including a successive-approximation-type AD converter will be described.

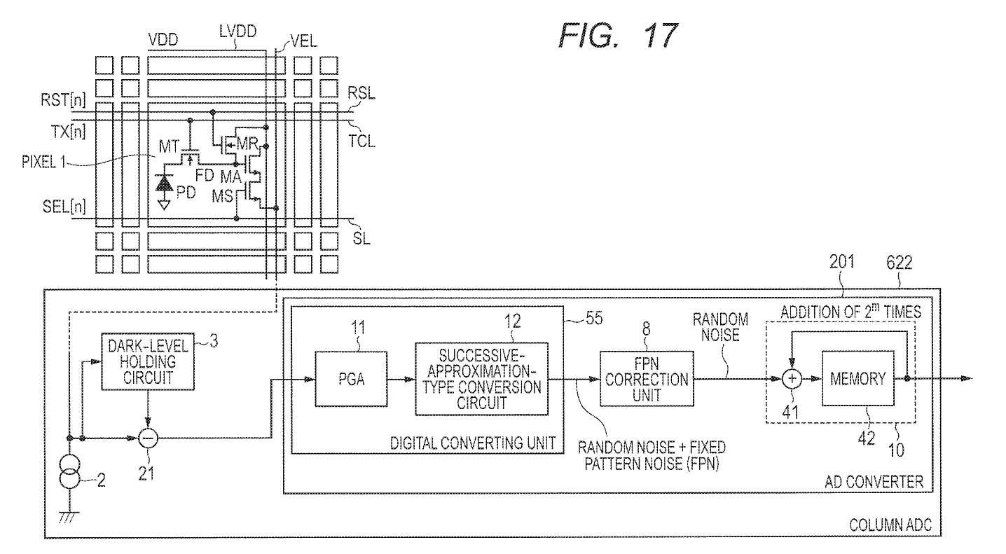

FIG. 17 is a diagram illustrating the configuration of the pixel 1 and a column ADC 622 of the ninth embodiment.

In FIG. 17, the pixel 1 in one column in the n-th row in the pixel array 113 is illustrated.

Since the pixel 1 is similar to that in the third to eighth embodiments and the reference example 2, description will not be repeated.

The column ADC 622 has the current source 2, the dark-level holding circuit 3, the subtractor 21, and an AD converter 201. The AD converter 201 is a successive-approximation-type converter and has a digital converting unit 55, the FPN correction unit 8, and the addition circuit 10. The digital converting unit 55 has a PGA (Programmable Gain Amplifier) 11 and a successive-approximation-type conversion circuit 12.

Since the current source 2, the dark-level holding circuit 3, and the subtractor 21 are similar to those in the third to eighth embodiments and the reference example 2, the description will not be repeated.

The digital converting unit 55 converts the difference signal between each of 2^{m} pieces of pixel signals output from the same pixel 1 at different times and one dark-level signal output from the same pixel 1 into a digital value of (n−m) bits.

The PGA 11 corresponds to an analog amplification circuit and is provided in the preceding stage of the successive-approximation-type conversion circuit 12. The PGA 11 amplifies an analog signal output from the subtractor 21.

The successive-approximation-type conversion circuit 12 samples an analog signal output from the PGA in each conversion period and compares it with a comparison signal. The successive-approximation-type conversion circuit 12 executes the comparing operation (n−m) times while performing successive approximation with the comparison signal bit by bit, and outputs digital data of (n−m) bits. m denotes a natural number. The successive-approximation-type conversion circuit 12 outputs the digital data of (n−m) bits in each of 2^{m} conversion periods.

The FPN correction unit 8 eliminates fixed pattern noise included in an output of the successive-approximation-type conversion circuit 12.

The addition circuit 10 integrates 2^{m} (n−m) bits from which the fixed noise is eliminated by the FPN correction unit 8, thereby outputting n bits. The addition circuit 10 has the adder 41 and the memory 42.

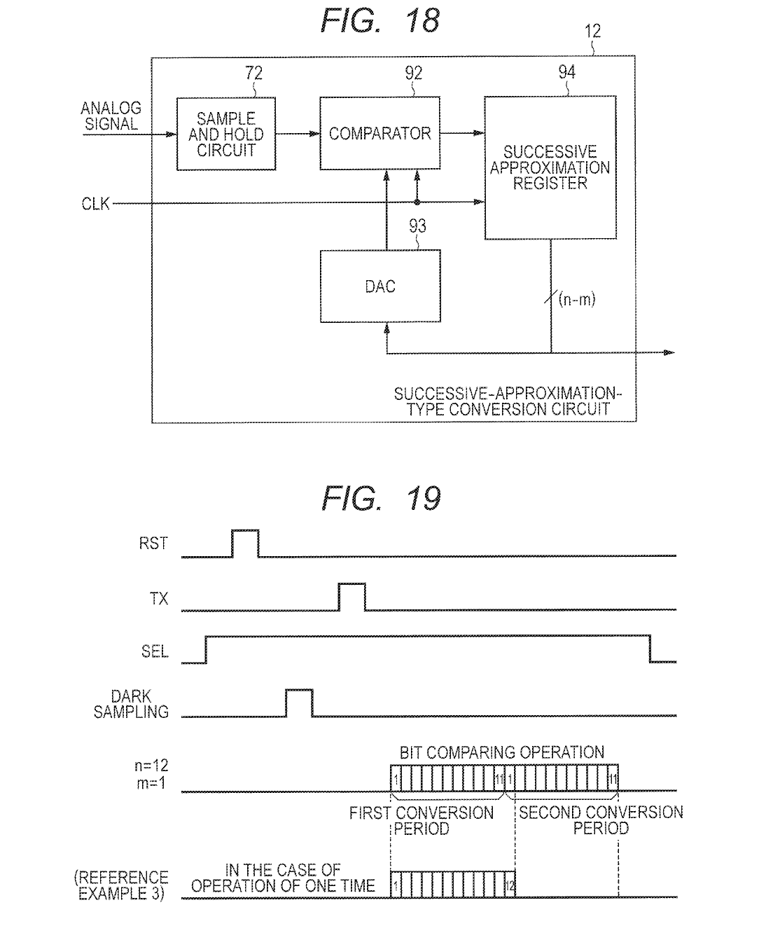

FIG. 18 is a diagram illustrating the configuration of the successive-approximation-type conversion circuit 12.

The successive-approximation-type conversion circuit 12 has a comparator 92, a DAC 93, and a successive-approximation register 94.

A sample and hold circuit 72 samples and holds an analog signal output from the PGA 11. The analog signal is a signal obtained by analog-amplifying the difference value between a pixel signal and a signal of dark level. The sample and hold circuit 72 resets the held analog signal in the beginning of each conversion period and newly samples and holds an analog signal.

The successive approximation register 94 holds digital data of (n−m) bits.

First, “1” is set in the MSB of the digital data of (n−m) bits in the successive approximation register 94, and all of the other bits are set to “0”.

The DAC 93 converts a digital value of (n−m) bits in the successive approximation register 94 to an analog value.

The comparator 92 compares the magnitude of the analog signal from the sample and hold circuit 72 and the magnitude of an output signal of the DAC 93. When the analog signal from the sample and hold circuit 72 is larger than the output signal of the DAC 93, the MSB of the digital data of (n−m) bits in the successive approximation register 94 is determined as “1”. When the analog signal from the sample and hold circuit. 72 is equal to or smaller than the output signal of the DAC 93, the MSB of the digital data of the (n−m) bits in the successive approximation register 94 is determined as “0”.

By repeating the above-described operation bit by bit in order on the bits of the digital data in the successive approximation register 94 to the LSB, all of the bits of the digital data of the (n−m) bits in the successive approximation register 94 are determined and output as digital data obtained by converting the analog signal.

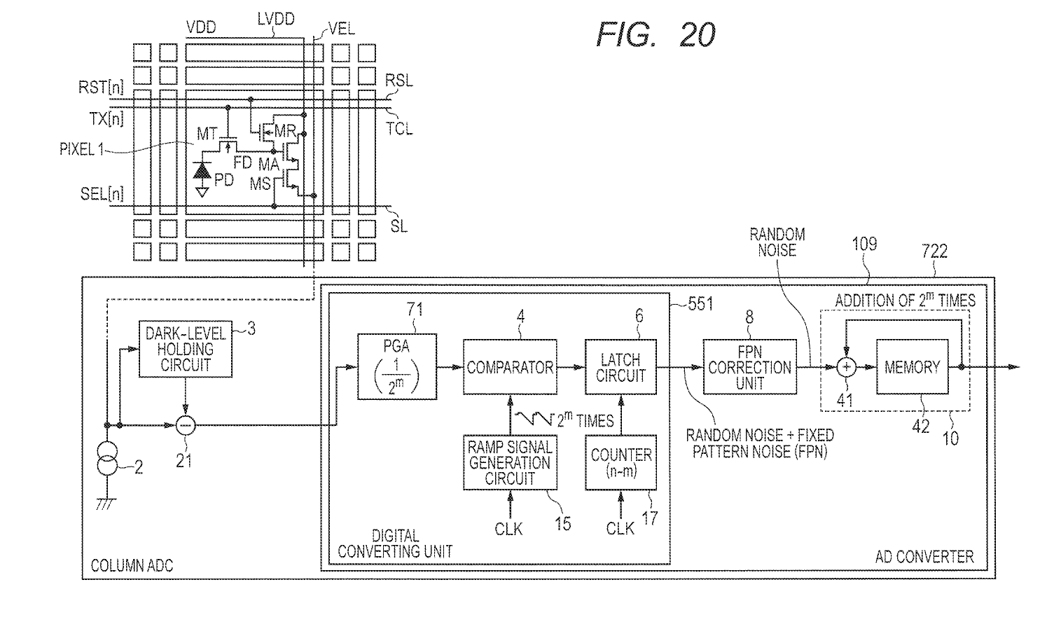

FIG. 19 is a timing chart of operation of the pixel 1 and the column ADC 622 when n=12 and m=1 in the ninth embodiment.

Like in the reference example 2, correlation double sampling is performed.

In the first conversion period, the following is executed.

According to the timing signal TA1 output from the timing generation circuit 112, the successive-approximation-type conversion circuit 12 compares the analog signal output from the PGA 11 with a comparison signal. By executing the comparing operation 11 times while performing successive approximation with comparison voltage bit by bit, digital data of 11 bits is output.

The FPN correction unit 8 eliminates fixed noise in a signal output from the successive-approximation-type conversion circuit 12.

The addition circuit 10 adds the initial value 0 held in the memory 42 and a count value from which the fixed noise is eliminated and which is output from the FPN correction unit 8 and holds the resultant in the memory 42.

In the second conversion period, like in the first conversion period, the PGA 11, the successive-approximation-type conversion circuit 12, and the FPN correction unit 8 operate.

The addition circuit 10 adds a digital value of 11 bits of the previous time held in the memory 42 and a digital value of 11 bits from which fixed noise is eliminated and which is output from the FPN correction unit 8, the resultant data is held in the memory 42, and data of 12 bits added is output from the memory 42.

In FIG. 19, the timing of conversion of the reference example 3 is also illustrated. In the reference example 3, by executing the comparing operation twelve times while performing successive approximation using the comparison signal bit by bit in one conversion period, the successive-approximation-type conversion circuit 12 outputs one piece of digital data of 12 bits.

As in the above-described example, when m=1, although there is one conversion period in the reference example 3, there are two conversion periods in this embodiment. Although the comparing operations of 12 times are necessary in one conversion period in the reference example 3, in the embodiment, the number of times of the comparing operations in one conversion period can be reduced to 11 times.

In the embodiment, although time of reading one pixel is longer than that in the third to eighth embodiments, the use value is high particularly in the use where there is little limit in the reading time. For example, in the case of imaging a dark subject by making exposure time longer than the time of the frame rate, both sensitivity and noise can be improved, so that a clearer image can be obtained.

### Modification of Ninth Embodiment

In the ninth embodiment, the configuration of the AD converter (except for the configuration of the digital converting unit) corresponds to that in the third embodiment. It is, however, not limited to the configuration but a configuration corresponding to any of those of the fourth to eighth embodiments may be also employed. For example, when the configuration of the AD converter corresponds to that in the fifth embodiment, the operation is as follows.

The digital converting unit 55 of the successive approximation type converts the difference signal between each of 2^{k} pixel signals output from the same pixel 1 at different times and one signal of dark level output from the same pixel 1 into a digital value of (n−m) bits. The addition circuit 10 integrates the 2^{k} (n−m) bits from which fixed noise is eliminated by the FPN correction unit 8. The digital amplification circuit multiplies an output of the addition circuit 10 2^{m-k} times.

### Tenth Embodiment

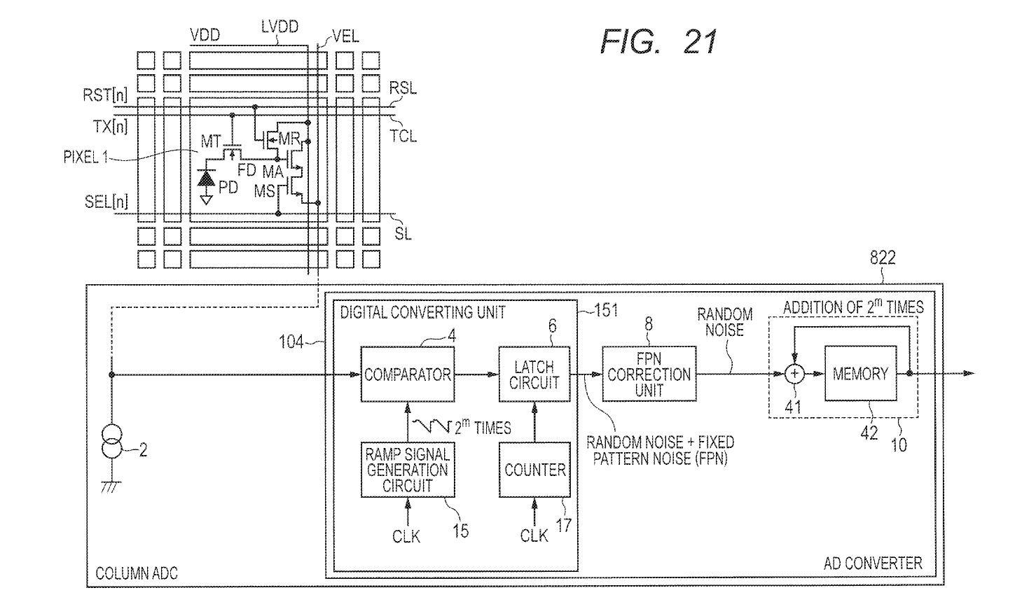

FIG. 20 is a diagram illustrating the configuration of the pixel 1 and a column ADC 722 of a tenth embodiment.

The column ADC 722 of the tenth embodiment is different from the column ADC 122 of the third embodiment with respect to the point that a digital converting unit 551 included in the column ADC 722 of the tenth embodiment has a PGA 71.

The PGA 71 is provided in the preceding stage of the comparator 4. The PGA 71 attenuates the magnitude of an analog signal output from the subtractor 21 to 1/2^{m}. Since the amplitude of the ramp signal RAMP to be compared with the analog signal is also reduced to 1/2^{m}, according to the embodiment, not only an image signal of low illumination but also an image signal of high illumination can be properly converted to digital data.

As described above, in the embodiment, although the gain cannot be increased, in a manner similar to the third embodiment, random noise can be lessened and the S/N ratio can be increased.

### Eleventh Embodiment

An AD converter of an eleventh embodiment converts a pixel signal itself to digital data without using correlation double sampling using the difference between a pixel signal and a signal of dark level.

FIG. 21 is a diagram illustrating the configuration of the pixel 1 and a column ADC 822 of the eleventh embodiment.

The column ADC 822 of the eleventh embodiment is different from the column ADC 122 of the third embodiment with respect to the point that the column ADC 822 of the eleventh embodiment does not have the dark-level holding circuit 3 and the subtractor 21.

The operation of the digital converting unit 51, the FPN correction unit 8, and the addition circuit 10 is similar to the operation described in the third embodiment except that a signal supplied to the digital converting unit 51 is different from that in the third embodiment. The digital converting unit 51 converts, not the difference value between a pixel signal and a signal of dark level, a pixel signal into digital data.

According to the eleventh embodiment, read noise can be eliminated also in the case where correlation double sampling is not used.

### Twelfth Embodiment

The AD converter in the third to eleventh embodiments converts a plurality of difference signals between a plurality of pixel signals from the same pixel and one signal of dark level into digital data.

On the other hand, an AD converter of a twelfth embodiment converts a plurality of signals of dark level from the same pixel to digital data, converts a plurality of pixel signals from the same pixel to digital data, and outputs the difference of them.

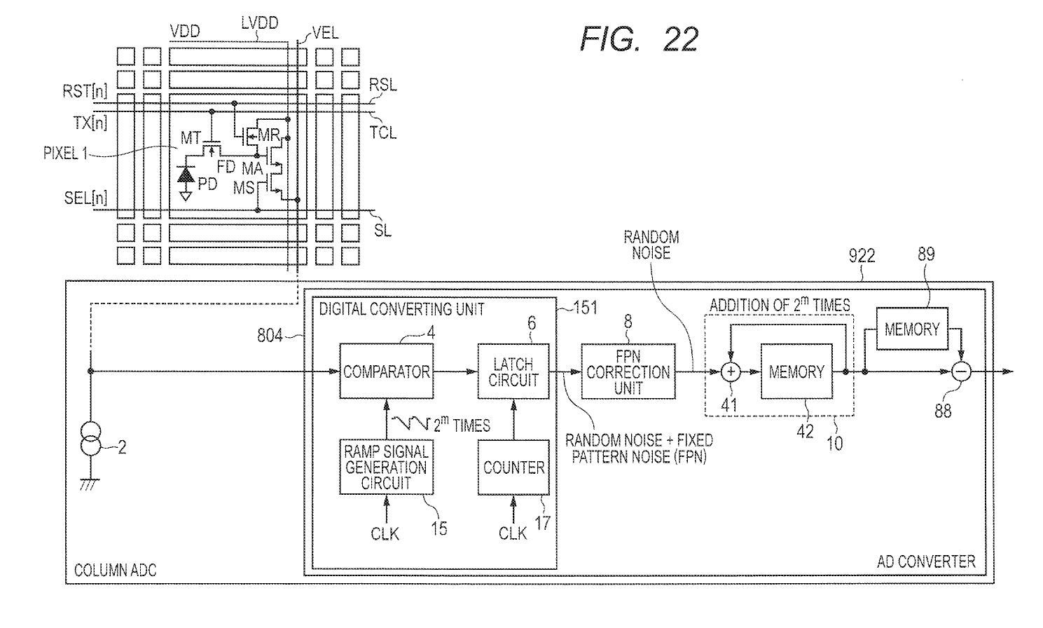

FIG. 22 is a diagram illustrating the configuration of the pixel 1 and a column ADC 922 of the twelfth embodiment.

The column ADC 922 of the twelfth embodiment is different from the column ADC 122 of the third embodiment with respect to the point that the column ADC 922 of the twelfth embodiment does not have the dark-level holding circuit 3 and the subtractor 21 but has a memory 89 and a subtractor 88.

The operation of the digital converting unit 51, the FPN correction unit 8, and the addition circuit 10 is similar to the operation described in the second embodiment. A signal supplied to the digital converting unit 51 is different from that in the second embodiment.

The digital converting unit 51 converts each of 2^{m} pieces of signals of dark output from the same pixel 1 at different times to a digital value of (n−m) bits and outputs 2^{m} pieces of first digital values. The digital converting unit 51 converts each of 2^{m} pieces of pixel signals output, from the same pixel 1 at different times to a digital value of (n−m) bits and outputs 2^{m} pieces of second digital values.

The addition circuit 10 integrates the converted 2^{m} pieces of first digital values to calculate a dark-level conversion value, and stores it into the memory 89. The addition circuit 10 integrates the converted 2^{m} pieces of second digital values to calculate a pixel conversion value.

The subtractor 88 subtracts the dark level conversion value held in the memory 89 from the pixel conversion value and outputs the difference value to the outside of the column ADC 922.

As described above, according to the embodiment, random noise can be suppressed not only in a pixel signal but also in a signal of dark level.

### Modification of Twelfth Embodiment

Although the configuration of the AD converter in the twelfth embodiment corresponds to that of the third embodiment, the invention is not limited to the case. It may correspond to that of the fourth to eighth embodiments. For example, when the configuration of the AD converter corresponds to that of the fifth embodiment, operation is performed as follows.

The digital converting unit 51 converts each of 2^{m} pieces of signals of dark level output from the same pixel 1 at different times to a digital value of (n−m) bits and outputs 2^{k} pieces of first digital values. The digital converting unit 51 converts each of 2^{k} pieces of pixel signals output from the same pixel 1 at different times to a digital value of (n−m) bits and outputs 2^{m} pieces of second digital values.

The addition circuit 10 integrates the converted 2^{k} pieces of first digital values to calculate a first addition value. The addition circuit 10 integrates the converted 2^{k} pieces of second digital values to calculate a second addition value.

The digital amplification circuit multiplies the first addition value output from the addition circuit 10 2^{m-k} times to calculate a dark-level conversion value, and stores the dark-level conversion value to the memory 89. The digital amplification circuit multiplies the second addition value output from the addition circuit 10 2^{m-k} times to calculate a pixel conversion value.

The subtractor 88 subtracts the dark level conversion value held in the memory 89 from the pixel conversion value and outputs the difference value to the outside of the column ADC 922.

### Supplementary Note

The present disclosure also includes the following inventions.

### Supplementary Note 1

An AD converter outputting (n+m−j) bits, includes:

a digital converting unit converting each of 2^{j} pieces of analog signals output from the same place at different times to a digital value of (n−j) bits;

an addition circuit integrating the 2^{j} pieces of converted digital values; and

a division circuit attenuating an output of the addition circuit to 1/2^{j-m} time,

in which n denotes a natural number of 1 or larger, j denotes a natural number of 2 or larger and less than n, and m denotes a natural number of 1 or larger and less than j.

### Supplementary Note 2

An AD converter outputting n bits, includes:

a digital converting unit converting each of 2^{j} pieces of analog signals output from the same place at different times to a digital value of (n−m) bits;

an addition circuit integrating the 2^{j} pieces of converted digital values; and

a division circuit attenuating an output of the addition circuit to 1/2^{j-m} time,

in which n denotes a natural number of 1 or larger, j denotes a natural number of 2 or larger and less than n, and m denotes a natural number of 1 or larger and less than j.

### Supplementary Note 3

A solid-state image sensing device includes:

a pixel array in which a plurality of pixels outputting signals by photoelectric conversion are disposed in rows and columns; and

a plurality of column ADCs provided in correspondence with a plurality of columns of the pixel array, respectively, and converting voltage signals of a plurality of pixels read from a selected row in the pixel array to digital signals,

in which each of the plurality of column ADCs includes:

a digital converting unit converting each of P pieces of pixel signals output from the same pixel at different times to a digital value of (n−m) bits; and

an addition circuit integrating the P pieces of converted digital values.

Although the present invention achieved by the inventors herein has been concretely described above on the basis of the embodiments, obviously, the invention is not limited to the embodiments and can be variously changed without departing from the gist.

What is claimed is:

1. An AD converter outputting n bits, comprising:
a digital converting unit converting each of P pieces of analog signals output from the same place at different times to a digital value of (n−m) bits; and
an addition circuit integrating the P pieces of converted digital values,
wherein n denotes a natural number of 1 or larger, m denotes a natural number of 1 or larger and less than n, and P denotes a natural number of 1 or larger and m or less.

2. The AD converter according to claim 1, wherein the P denotes 2^{m}.

3. The AD converter according to claim 2, wherein the digital converting unit is an integration-type conversion circuit.

4. The AD converter according to claim 3, wherein the digital converting unit comprises:
a counter of (n−m) bits updating a counter value synchronously with a reference clock to a conversion period;
a ramp signal generation circuit generating a ramp signal whose magnitude changes synchronously with the reference clock in an amplitude range according to the number of bits of the counter in the conversion period;
a comparator comparing the magnitude of the analog signal and the magnitude of the ramp signal in the conversion period; and
a latch circuit latching an output of the counter when an output of the comparator changes in the conversion period, and
wherein the conversion period is repeated 2^{m} times.

5. The AD converter according to claim 4, wherein the ramp signal generation circuit is configured that tilt of the ramp signal can be adjusted.

6. The AD converter according to claim 2, wherein the digital converting unit is a successive-approximation-type conversion circuit.

7. The AD converter according to claim 1,
wherein the P is 2^{k}, and
wherein a digital amplification circuit amplifying an output of the addition circuit to 2^{m-k} times where m>k is provided.

8. The AD converter according to claim 7, wherein the digital converting unit is an integration-type conversion circuit.

9. The AD converter according to claim 8, wherein the digital converting unit comprises:
a counter of (n−m) bits updating a counter value synchronously with a reference clock in a conversion period;
a ramp signal generation circuit generating a ramp signal whose magnitude changes synchronously with the reference clock in an amplitude range according to the number of bits of the counter in the conversion period;
a comparator executing comparison between the magnitude of the analog signal and the magnitude of the ramp signal in the conversion period; and
a latch circuit latching an output of the counter when an output of the comparator changes in the conversion period, and
wherein the conversion period is repeated 2^{k} times.

10. The AD converter according to claim 9, wherein the ramp signal generation circuit is configured that tilt of the ramp signal can be adjusted.

11. The AD converter according to claim 7, wherein the digital converting unit is a successive-approximation-type conversion circuit.

12. The AD converter according to claim 1, wherein a PGA (Programmable Gain Amplifier) is provided in a preceding stage of the digital converting unit.

13. The AD converter according to claim 1, wherein an FPN correction unit is provided in a preceding stage of the addition circuit.

14. A solid-state image sensing device comprising:
a pixel array in which a plurality of pixels outputting signals by photoelectric conversion are disposed in rows and columns; and
a plurality of column ADCs provided in correspondence with a plurality of columns of the pixel array, respectively, and converting voltage signals of a plurality of pixels read from a selected row in the pixel array to digital signals,
wherein each of the plurality of column ADCs includes:
a digital converting unit converting a difference signal between each of P pieces of pixel signals output from the same pixel at different times and a signal of dark level output from the same pixel to a digital value of (n−m) bits; and
an addition circuit integrating the P pieces of converted digital values.

15. A solid-state image sensing device comprising:
a pixel array in which a plurality of pixels outputting signals by photoelectric conversion are disposed in rows and columns; and
a plurality of column ADCs provided in correspondence with a plurality of columns of the pixel array, respectively, and converting voltage signals of a plurality of pixels read from a selected row in the pixel array to digital signals,
wherein each of the plurality of column ADCs includes:
a digital converting unit converting each of P pieces of signals of dark level output from the same pixel at different times to a digital value of (n−m) bits, outputting P pieces of first digital values, converting each of P pieces of pixel signals output from the same pixel at different times to a digital value of (n−m) bits, and outputting P pieces of second digital values;
an addition circuit integrating the P pieces of converted first digital values to calculate a dark-level conversion value, and integrating the P pieces of converted second digital values to calculate a pixel conversion value; and
a subtractor calculating a difference value between the pixel conversion value and the dark-level conversion value.
